(19) United States
(12) Patent Application Publication
(10) Pub. No.: US 2011/0229774 A1
(43) Pub. Date: Sep. 22, 2011

(54) LITHIUM ION BATTERY

(75) Inventor: Takahiro YAMAKI, Hitachinaka (JP)

(73) Assignee: Hitachi, Ltd.

(21) Appl. No.: 13/034,524

(22) Filed: Feb. 24, 2011

(30) Foreign Application Priority Data
Mar. 17, 2010 (JP) 2010-060110

(51) Int. Cl. H01M 10/02

(52) U.S. Cl. 429/338; 429/324

(57) ABSTRACT

The present invention provides a lithium ion battery which is protected from deterioration in performance due to oxidation decomposition of the nonaqueous electrolyte solution and excels in cycle life. The lithium ion battery has a cathode including a cathode active material exhibiting a potential of 4.5 V or more with reference to lithium metal; an anode; and a nonaqueous electrolyte solution containing a nonaqueous solvent and at least one lithium salt dissolved in the nonaqueous solvent. The nonaqueous solvent mainly contains a cyclic carbonate and a chain carbonate. The nonaqueous electrolyte solution contains boron ethoxide.

### CLAIM OF PRIORITY

The present application claims priority from Japanese Patent Application JP 2010-060110 filed on Mar. 17, 2010, the content of which is hereby incorporated by reference into this application.

### FIELD OF THE INVENTION

The present invention relates to a high-voltage lithium ion battery using a cathode active material that exhibits a high potential of 4.5 V or more with reference to lithium metal.

### BACKGROUND OF THE INVENTION

There is a growing demand for lithium ion batteries that exhibit higher voltages than conventional lithium ion batteries do (about 4 V). These high-voltage lithium ion batteries are used in series of multiple batteries as power sources in electric vehicles (EVs), hybrid EVs, and in electric power storage, or as power sources with higher energy densities.

Such conventional lithium ion batteries exhibiting voltages of about 4 V widely employ a nonaqueous electrolyte solution containing a lithium salt in a nonaqueous solvent that mainly contains a carbonate-based solvent.

Specifically, the lithium ion batteries employ a carbonate-based electrolyte solution as a solution of at least one lithium salt, such as LiPF₆ or LiBF₄, in a solvent mixture containing a cyclic carbonate with a high dielectric constant, and a chain carbonate. Examples of such a cyclic carbonate include ethylene carbonate (EC) and propylene carbonate (PC). Examples of such a chain carbonate include dimethyl carbonate (DMC), diethyl carbonate (DEC), and methyl ethyl carbonate (MEC).

The carbonate-based electrolyte solution has the characteristics of good balance between oxidation resistance and reduction resistance, and of excellent lithium ion conductivity.

However, the solvent of the carbonate-based electrolyte solution is oxidatively decomposed at the surface of the cathode active material in the lithium ion batteries using the cathode active material exhibiting a high potential of 4.5 V or more with reference to lithium metal.

This causes the lithium ion batteries using the cathode active material exhibiting a high potential of 4.5 V or more with reference to lithium metal to have a shorter cycle life.

To solve the problem, for example, Japanese Unexamined Patent Application Publication (JP-A) No. 2004-241339 discloses a lithium ion battery using a solvent in which halogen atoms such as fluorine substitute for hydrogen atoms constituting the carbonate. Japanese Unexamined Patent Application Publication (JP-A) No. 2002-110225 discloses a lithium ion battery using an ambient-temperature molten salt. The solvents used in these lithium ion batteries, however, are problematic in reduction resistance or in lithium ion conductivity.

Independently, there are techniques of adding small amounts of additives to nonaqueous electrolyte solutions. For example, Japanese Unexamined Patent Application Publication (JP-A) No. 2005-149750 discloses an electrolyte solution further containing a sulfonic acid ester. Japanese Unexamined Patent Application Publication (JP-A) No. 2008-288049 discloses a lithium ion battery using a specific boron-based or phosphorus-based salt of lithium. The resulting electrolyte solutions further containing small amounts of additives, however, do not sufficiently exhibit the effects.

As is described above, the decrease in life cycle due to oxidation decomposition of the solvent in the nonaqueous electrolyte solution has not been sufficiently improved or prevented according to the known techniques in lithium ion batteries using a cathode active material that exhibits a high potential of 4.5 V or more with reference to lithium metal.

Accordingly, an object of the present invention is to provide a lithium ion battery which excels in cycle life.

### SUMMARY OF THE INVENTION

The present invention provides a lithium ion battery which has a cathode including a cathode active material exhibiting a potential of 4.5 V or more with reference to lithium metal; an anode; and a nonaqueous electrolyte solution containing a nonaqueous solvent and at least one lithium salt dissolved in the nonaqueous solvent. The nonaqueous solvent contains a cyclic carbonate and a chain carbonate. The nonaqueous electrolyte solution contains a material represented by the following Chemical Formula 1:

B(OR¹)(OR²)(OR³) [1]

wherein at least one of R¹, R², and R³ is an alkyl group having two carbon atoms; B represents boron; and O represents oxygen.

The alkyl groups R¹, R², and R³ may be different from each other.

Preferably, the material represented by the Chemical Formula 1 is a boron alkoxide.

Preferably, the nonaqueous solvent contains an ethylene carbonate (EC) as the cyclic carbonate and contains at least one of dimethyl carbonate (DMC) and methyl ethyl carbonate (MEC) as the chain carbonate

Preferably, each of the alkyl groups R¹, R², and R³ of the material represented by the Chemical Formula 1 has two carbon atoms.

Preferably, the boron alkoxide is a boron ethoxide.

Preferably, the nonaqueous electrolyte solution contains the boron ethoxide in a content of 0.2 weight percent or more and 4.0 weight percent or less

The present invention provides lithium ion batteries which excel in cycle life.

### BRIEF DESCRIPTION OF DRAWINGS

FIG. 1 is a graph showing the difference in cyclic voltammetry between a nonaqueous electrolyte solution with boron ethoxide and another nonaqueous electrolyte solution without boron ethoxide; and

FIG. 2 is a schematic cross-sectional view of a button-shaped lithium ion battery according to an embodiment of the present invention.

### DESCRIPTION OF EMBODIMENTS

A lithium ion battery according to an embodiment of the present invention has a cathode including a cathode active material that exhibits a potential of 4.5 V or more with reference to lithium metal; an anode; and a nonaqueous electrolyte solution containing a nonaqueous solvent and at least one lithium salt dissolved in the nonaqueous solvent.

In a preferred embodiment, the nonaqueous solvent contains an ethylene carbonate as a cyclic carbonate and contains at least one of dimethyl carbonate and methyl ethyl carbonate as a chain carbonate. In another preferred embodiment, the nonaqueous electrolyte solution contains a boron ethoxide in a content of 0.2 weight percent or more and 4.0 weight percent or less.

A nonaqueous electrolyte solution where a lithium salt is dissolved in a solvent mixture containing a cyclic carbonate and a chain carbonate has good balance between oxidation resistance and reduction resistance and excels in lithium ion conductivity.

However, in such a lithium ion battery using the cathode active material exhibiting a high potential of 4.5 V or more with reference to lithium metal, the solvent of the carbonate-based electrolyte solution is oxidatively decomposed at the surface of the cathode active material. The resulting lithium ion battery suffers from poor oxidation resistance.

This causes the lithium ion battery using the cathode active material exhibiting a high potential of 4.5 V or more with reference to lithium metal to have a shorter cycle life.

The present inventors have found that the addition of boron ethoxide to the nonaqueous electrolyte solution prevents the decrease in the cycle life of the lithium ion battery using the cathode active material that exhibits a high potential of 4.5 V or more with reference to lithium metal.

The boron ethoxide is a material represented by the Chemical Formula B(OR¹)(OR²)(OR³) wherein R¹, R², and R³ are alkyl groups having two carbon atoms; B is boron; and O is oxygen.

Activities of boron ethoxide are deduced as follows.

The added boron ethoxide is oxidatively decomposed at the surface of the cathode (surface of the cathode active material and conducting agent) at cathode potentials of 4.5 V or more with reference to lithium metal.

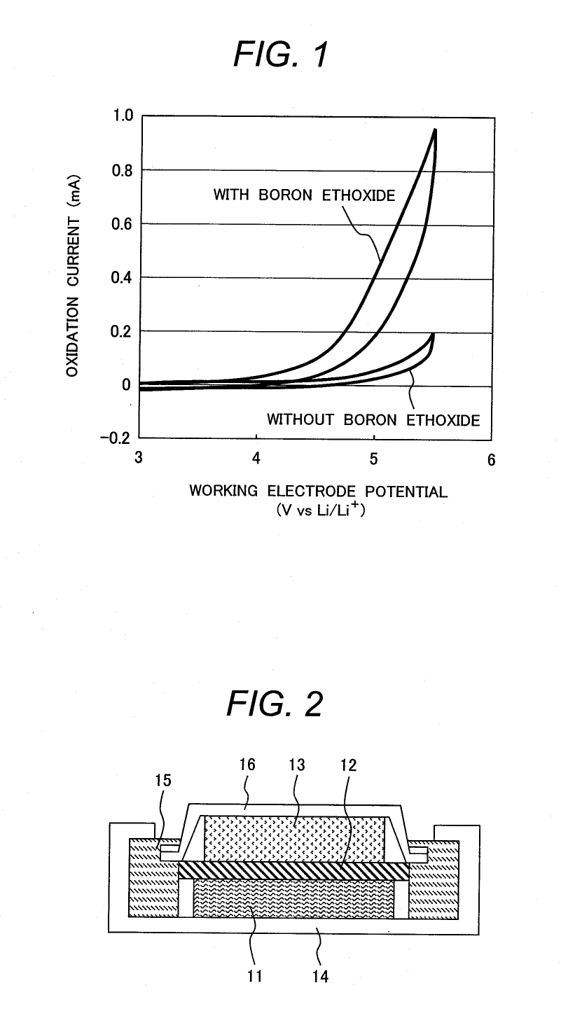

FIG. 1 is a graph showing the difference in cyclic voltammetry between a nonaqueous electrolyte solution containing boron ethoxide and another nonaqueous electrolyte solution containing no boron ethoxide.

Specifically, FIG. 1 shows how the oxidation current varies depending on the working electrode potential (with reference to lithium metal), and this is compared in cyclic voltammetry between a nonaqueous electrolyte solution “with” boron ethoxide in a content of 4 weight percent and a nonaqueous electrolyte solution “without” boron ethoxide. The original nonaqueous electrolyte solution is a solution of 1 mol/dm³ of lithium hexafluorophosphate as a lithium salt, in a 2:4:4 (by volume) nonaqueous solvent mixture of ethylene carbonate, dimethyl carbonate, and methyl ethyl carbonate. The oxidation current herein indicates the oxidation reaction rate at the cathode surface.

As compared to the nonaqueous electrolyte solution “without” boron ethoxide, the nonaqueous electrolyte solution “with” boron ethoxide shows an abruptly increasing oxidation current at working electrode potentials of 4.5 V or more, demonstrating that the oxidation decomposition reaction of boron ethoxide proceeds at the cathode surface.

The addition of boron ethoxide protects the lithium ion battery from having a shortened cycle life. This is probably because the decomposition product of boron ethoxide forms a kind of protective film on the surface of the cathode active material, and this suppresses the oxidation decomposition of the solvent in the nonaqueous electrolyte solution.

In this process, the presence of an alkoxy group having two carbon atoms (ethoxy group) helps to form a satisfactory protective film on the surface of the cathode active material.

When all the alkoxy groups constituting the boron alkoxide are alkoxy groups having one carbon atom (methoxy groups), those having three carbon atoms (propoxy groups), or those having four carbon atoms (butoxy group), the boron alkoxide may not effectively form a satisfactory protective film, and the oxidation decomposition product of the boron alkoxide may adversely affect the cycle life contrarily.

The three alkoxy groups (OR¹, OR², and OR³) constituting the boron alkoxide of the Chemical Formula 1 may be different from each other or may be same. At least one of the alkoxy groups should be ethoxy group having two carbon atoms.

Some of hydrogen atoms of alkyl groups constituting the alkoxy groups may be substituted with halogen atoms such as fluorine atoms.

Preferably, the boron alkoxide has alkoxy groups, each of which has two carbon atoms. The resulting boron alkoxide may form a more satisfactory protective film to give a lithium ion battery having a better cycle life.

More preferably, the boron ethoxide has alkoxy groups, each of which has two carbon atoms. The resulting boron ethoxide may form a more satisfactory protective film to give a lithium ion battery having an even better cycle life.

Preferably, the nonaqueous electrolyte solution contains boron ethoxide in a content of 0.2 weight percent or more and 4.0 weight percent or less.

Boron ethoxide in a content of less than 0.2 weight percent may not sufficiently exhibit its activity. In contrast, boron ethoxide in a content of more than 4.0 weight percent may require an excessively large quantity of electricity for its oxidation decomposition, and this may impair the cycle life.

Preferably, the nonaqueous electrolyte solution contains ethylene carbonate as the cyclic carbonate and contains at least one of dimethyl carbonate and methyl ethyl carbonate as the chain carbonate. The resulting lithium ion battery has a further excellent cycle life, because the nonaqueous electrolyte solution helps to increase the lithium ion conductivity and to provide a better balance between the reduction resistance and the oxidation resistance.

In addition to or instead of the above-mentioned components, the nonaqueous solvent may contain, for example, one or more of propylene carbonate, butylene carbonate, diethyl carbonate, and methyl acetate.

The nonaqueous electrolyte solution may further contain a variety of additives within ranges not adversely affecting the objects of the present invention. Typically, the nonaqueous electrolyte solution may further contain a phosphoric ester, such as triethyl phosphate, for imparting fire retardancy to the lithium ion battery.

Examples of lithium salts for constituting the nonaqueous electrolyte solution for use herein include LiClO₄, LiCF₃SO₃, LiPF₆, LiBF₄, and LiAsF₆. These lithium salts may be used alone or in combination.

The types and amounts of the solvent, lithium salt, and boron alkoxide of the nonaqueous electrolyte solution for use herein may be identified or determined, for example, based on molecular weight analysis typically through gas chromatography-mass spectrometry (GC-MS), as well as based on the quantitatively determined amounts of boron and other metal elements and of fluorine element typically through inductively coupled plasma spectrometry or atomic absorption spectrophotometry.

As described above, the lithium ion battery has a cathode including a cathode active material exhibiting a potential of 4.5 V or more with reference to lithium metal; an anode; and a nonaqueous electrolyte solution containing a nonaqueous solvent and at least one lithium salt dissolved in the nonaqueous solvent. Preferably, the nonaqueous solvent contains ethylene carbonate and at least one of dimethyl carbonate and methyl ethyl carbonate, and the nonaqueous electrolyte solution contains boron ethoxide in a content of 0.2 weight percent or more and 4.0 weight percent or less.

The cathode for use herein includes a cathode active material that exhibits a potential of 4.5 V or more with reference to lithium metal.

Examples of such cathode active materials include spinel-type oxides represented by the General Chemical Formula LiMn_{2-X}M_{X}O₄; and so-called olivine-type oxides represented by the General Chemical Formula LiMPO₄ (M denotes at least one selected from the group consisting of Ni and Co).

Among them, preferred is a spinel-type oxide represented by the Compositional Formula: Li₁₊ₐMn_{2-a-x-y}NiₓM_{y}O₄, wherein 0≦a≦0.1; 0.3≦x≦0.5; 0≦y≦0.2; and M denotes at least one selected from the group consisting of Cu, Co, Mg, Zn, and Fe. This spinel-type oxide is advantageous for allowing the cathode active material to stably exhibit a potential of 4.5 V or more with reference to lithium metal.

In the spinel-type oxide, the nickel (Ni) content (x) is preferably 0.4 to 0.5 and more preferably 0.45 to 0.50.

As in the above embodiment, a high-voltage lithium ion battery having a high capacity and an especially excellent cycle life can be obtained by the use of the specific active material exhibiting a potential of 4.5 V or more with reference to lithium metal in combination with the nonaqueous electrolyte solution containing boron ethoxide in a content of 0.2 to 4.0 weight percent. The specific cathode active material is a spinel-type oxide represented by the Compositional Formula: Li₁₊ₐMn_{2-a-x-y}NiₓM_{y}O₄ wherein 0≦a≦0.1; 0.45≦x≦0.50; 0≦y≦0.2; and M represents at least one selected from the group consisting of Cu, Co, Mg, Zn, and Fe.

The cathode active material may be synthetically prepared by a procedure as in processes for synthesizing regular inorganic compounds.

The spinel-type oxide may be synthetically prepared by weighing two or more compounds as raw materials so as to give a desired compositional ratio among Li (lithium), Mn (manganese) and the element M; blending them uniformly; and firing the mixture.

The raw-material compounds may be any of suitable oxides, hydroxides, chlorides, nitrates, and carbonates corresponding to the respective elements.

A compound containing two or more elements selected from the group consisting of Li, Mn, and the element M can be used as a raw material. For example, the raw material can be a hydroxide material prepared by precipitating Mn and the element M in a weakly alkaline aqueous solution as a wet material.

The cathode active material may be produced by repeating the blending process of raw materials and the firing process of the mixture. In this case, the blending conditions and firing conditions may be chosen suitably.

When the cathode active material is produced by repeating the blending process and the firing process, the raw materials may be added during the repeated blending processes so as to give a desired compositional ratio in the final firing process.

A high potential cathode for use herein is prepared by using the cathode active material, a conducting agent, and a binder.

Examples of such conducting agents include carbon materials such as carbon black, nongraphitizable carbon, graphitizable carbon, and graphite. Among them, the use of carbon black, in combination with nongraphitizable carbon as necessary, is preferred.

Examples of such binders include polymeric resins such as polyvinylidene fluorides, polytetrafluoroethylenes, poly(vinyl alcohol) derivatives, cellulose derivatives, and butadiene rubbers.

The cathode active material, the conducting agent, and the binder which is dissolved in a solvent such as N-methyl-2-pyrrolidone (NMP) may be used for the preparation of the cathode.

Specifically, a cathode mix slurry is prepared by weighing and blending the cathode active material, the conducting agent, and the solution containing the binder so as to give a desired composition to the slurry.

The cathode mix slurry is applied to a collector foil such as aluminum foil, dried, and pressed into a desired shape.

The workpiece is cut into a desired size and thereby yields the high potential cathode.

The anode for use herein may have the following configuration.

Exemplary anode active materials include, but are not limited to, carbon materials; lithium metal; lithium titanate; oxides typically of tin and silicon; and metals that can be alloyed with lithium, such as tin and silicon. Composite materials prepared by compounding these materials may also be used.

Among them, carbon materials such as graphite, graphitizable carbon, and nongraphitizable carbon are preferred as an anode active material for use in the high-voltage lithium ion battery, because these materials exhibit low potentials and excel in cyclic performance.

Specifically, an anode mix slurry is prepared in the same manner as in the cathode, by weighing and blending the anode active material, the solution containing the binder, and, according to necessity, a conducting agent such as carbon black so as to give a desired mix composition.

The anode mix slurry is applied to a collector foil such as copper foil, dried, and pressed into a desired shape.

The workpiece is cut into a desired size and thereby yields the anode.

A lithium ion battery according to this embodiment of the present invention is produced by using the high potential cathode, the anode, and the electrolyte solution.

Although being used for the preparation of a button-shaped lithium ion battery in this embodiment, the high potential cathode, the anode, and the electrolyte solution may be adopted to lithium ion batteries having various shapes, such as button shape, cylindrical shape, prismatic shape, and laminated shape.

A cylindrical lithium ion battery may be prepared in the following manner.

The cathode and anode are cut into strips and provided with terminals for deriving a current therefrom. A separator composed of a porous insulating film 15 to 50 μm thick is placed between the cathode and anode. The cathode, the anode, and the separator are wound into a cylinder to form a bundle of electrodes, which is then placed into a casing made typically of a stainless steel (SUS) or aluminum.

Exemplary separators for use herein include porous insulating films made of resins, such as polyethylenes, polypropylenes, and aramids. The porous insulating films can be further provided with a layer of inorganic compound, such as alumina (Al₂O₃).

The nonaqueous electrolyte solution is injected into the casing in dry air or in an inert gas atmosphere in a working chamber. The casing is end-sealed to give a cylindrical lithium ion battery.

A prismatic lithium ion battery may be prepared in the following manner.

A workpiece composed of the cathode, the anode, and the separator placed between the cathode and anode is prepared by the procedure as in the cylindrical lithium ion battery, wound with dual winding axes, and thereby yields an elliptic bundle of electrodes.

The elliptic bundle of electrodes is housed in a prismatic casing, the electrolyte solution is charged thereinto, and the casing is end-sealed in the same manner as in the cylindrical lithium ion battery.

Such a prismatic lithium ion battery may also be prepared by stacking the separator, cathode, separator, anode, and separator in this order to give a stack instead of the bundle of electrodes, and housing the stack in the prismatic casing.

A laminated lithium ion battery may be prepared in the following manner.

The separator, cathode, separator, anode, and separator are stacked in this order to give a stack, and the stack is housed in a pouched aluminum laminate sheet which is lined with an insulating sheet made typically of a polyethylene or a polypropylene.

Terminals for the electrodes are formed in an opening of the pouched laminate sheet. The electrolyte solution is injected into the laminate sheet through the opening, and the opening is end-sealed.

The lithium ion batteries according to the embodiments are used for various purposes and do not limit the application. They are suitable for power sources in which multiple batteries are connected in series, because they are high-voltage lithium ion batteries using the cathode active material that exhibits a high potential of 4.5 V or more with reference to lithium metal.

The lithium ion batteries may be used typically as power sources for electric vehicles (EVs) and hybrid EVs; power sources for industrial machines such as elevators, which have a system for recovering at least part of kinetic energy; and power sources for industrial or household power storage systems.

In addition, they may also be used as power sources typically for mobile devices, information appliances, household electric appliances, and electric tools.

The lithium ion batteries according to the embodiments will be illustrated in further detail below with reference to some working examples.

It should be noted, however, that these examples are never construed to limit the scope of the present invention.

### Example 1

Batteries A, B, C, D, E, and F as lithium ion batteries according to this example were prepared in the following manner.

Initially, a cathode was prepared.

LiMn_{1.52}Ni_{0.48}O₄ was prepared as a cathode active material that exhibited a potential of 4.5 V or more with reference to lithium metal.

Manganese dioxide (MnO₂) and nickel oxide (NiO) as raw materials were weighed so as to give a predetermined compositional ratio, and were wet-mixed with pure water in a satellite mill.

The mixture was dried, placed in a lidded alumina crucible, and fired in an electric furnace in an air atmosphere by heating at a rate of temperature rise of 3° C. per minute, holding at 1000° C. for 12 hours, and cooling at a rate of temperature drop of 2° C. per minute.

The burned substance was pulverized in an agate mortar, and this was wet-mixed, in the same manner as above, with lithium carbonate (Li₂CO₃) which had been weighed to give a predetermined compositional ratio.

The resulting mixture was dried, placed in a lidded alumina crucible, and fired in an electric furnace in an air atmosphere by heating at a rate of temperature rise of 3° C. per minute, holding at 800° C. for 20 hours, and cooling at a rate of temperature drop of 2° C. per minute.

This burned substance was pulverized in an agate mortar and thereby yielded a cathode active material.

A cathode mix slurry was prepared by mixing 87 weight percent of the above-prepared cathode active material, 6 weight percent of a carbon black having an average particle diameter of 50 nm and a specific surface area of 40 g/m², and, in terms of dry weight of polyvinylidene fluoride (PVDF), 7 weight percent of a solution of PVDF as a binder in N-methyl-2-pyrrolidone (NMP).

The cathode mix slurry was applied to an aluminum foil (cathode collector foil) 20 μm thick, and dried to give a weight of about 20 mg/cm² to the dried slurry.

This was punched to a diameter of 16 mm, compressed and molded using a pressing machine so as to give a predetermined mix density, and thereby yielded the cathode.

Next, an anode was prepared.

An anode mix slurry was prepared by mixing 92 weight percent of an artificial graphite as an anode active material with 8 weight percent of a solution of PVDF in NMP in terms of PVDF dry weight.

The anode mix slurry was applied to a copper foil (anode collector foil) 15 μm thick, and dried to give a weight of about 7 mg/cm² to the dried slurry.

This was punched to a diameter of 17 mm, compressed and molded using a pressing machine so as to give a predetermined mix density, and thereby yielded the anode.

A button-shaped lithium ion battery as schematically illustrated in FIG. 2 was prepared using the above-prepared cathode and anode.

FIG. 2 is a schematic cross-sectional view of the button-shaped lithium ion battery according to Example 1.

The anode 11, a porous separator 12 having a thickness of 30 μm, and the cathode 13 were stacked so that the cathode mix and the anode mix faced each other. The respective components were impregnated with a nonaqueous electrolyte solution.

After this was housed in a battery casing 14 serving also as an anode terminal, the battery casing 14 was caulked via a gasket 15 with a battery lid 16 serving also as a cathode terminal, thereby yielding the button-shaped lithium ion battery.

The nonaqueous electrolyte solution was prepared in the following manner.

Lithium hexafluorophosphate was dissolved as a lithium salt in a concentration of 1 mol/dm³ in a 2:4:4 (by volume) nonaqueous solvent mixture of ethylene carbonate, dimethyl carbonate, and methyl ethyl carbonate to give an original nonaqueous electrolyte solution.

The original nonaqueous electrolyte solution was combined with boron ethoxide (B(OC₂H₅)₃) in contents of 0.1 weight percent (Battery A), 0.2 weight percent (Battery B), 1.0 weight percent (Battery C), 2.0 weight percent (Battery D), 4.0 weight percent (Battery E), and 5.0 weight percent (Battery F) to give a series of the nonaqueous electrolyte solution.

### Comparative Example 1

In Comparative Example 1, button-shaped lithium ion batteries (Comparative Batteries) were prepared by the same procedure as in Example 1 except for the nonaqueous electrolyte solutions. Comparative Battery Z was prepared by using the original nonaqueous electrolyte solution without any boron alkoxide. Comparative Battery W was prepared by using the original nonaqueous electrolyte solution further containing 1.0 weight percent of boron methoxide (B(OCH₃)₃). Comparative Battery X was prepared by using the original nonaqueous electrolyte solution further containing 1.0 weight percent of boron isopropoxide (B(OCH(CH₃)₂)₃). Comparative Battery Y was prepared by using the original nonaqueous electrolyte solution further containing 1.0 weight percent of boron n-butoxide (B(OC₄H₉)₃).

[Charge-Discharge Test]

The batteries prepared according to Example 1 and Comparative Example 1 were subjected to charge-discharge tests.

The charging was carried out by performing a constant current (CC) charge at a charge current of 0.8 mA and a final voltage of 4.9 V, and immediately thereafter performing a constant voltage (CV) charge at a voltage of 4.9 V for 2 hours.

After the charging, the batteries were left in an open circuit state for 30 minutes.

The discharging was carried out by performing a constant current (CC) discharge at a discharge current of 0.8 mA and a final voltage of 3.0 V.

After the discharging, the batteries were left in an open circuit state for 30 minutes.

The one combination of the charging and discharging processes were counted as one cycle.

TABLE 1

| | | Content (weight | Capacity (%) |
|---|---|---|---|
| | Type of boron | percent) of boron | after 20 |
| | alkoxide | alkoxide | cycles |
| Battery A | Boron ethoxide | 0.1 | 93.8 |
| Battery B | | 0.2 | 95.6 |
| Battery C | | 1.0 | 95.5 |
| Battery D | | 2.0 | 95.5 |
| Battery E | | 4.0 | 94.8 |
| Battery F | | 5.0 | 93.0 |
| Comparative | Boron methoxide | 1.0 | 87.6 |
| Battery W | | | |
| Comparative | Boron isopropoxide | 1.0 | 91.0 |
| Battery X | | | |
| Comparative | Boron n-butoxide | 1.0 | 91.0 |
| Battery Y | | | |
| Comparative | — | 0.0 | 92.6 |
| Battery Z | | | |

Table 1 shows the batteries according to Example 1 and Comparative Example 1, the types and contents of the added boron alkoxides (boron ethoxide, boron methoxide, boron isopropoxide, and boron n-butoxide), and ratios of the discharge capacity after 20 cycles to the discharge capacity after one cycle.

The batteries according to Example 1 containing boron ethoxide in their nonaqueous electrolyte solutions had higher discharge capacities after 20 cycles and showed superior cycle lives, as compared to Comparative Battery Z without boron ethoxide, Comparative Battery W containing boron methoxide, Comparative Battery X containing boron isopropoxide, and Comparative Battery Y containing boron n-butoxide.

Among the batteries according to Example 1, Battery B, Battery C, Battery D, and Battery E containing boron ethoxide in contents of from 0.2 weight percent to 4.0 weight percent had further higher discharge capacities after 20 cycles and showed further superior cycle lives, as compared to Battery A containing boron ethoxide in a content of 0.1 weight percent and to Battery F containing boron ethoxide in a content of 5.0 weight percent.

### Example 2

A lithium ion battery (Battery G) according to Example 2 was prepared by the same procedure as in Example 1 except for the nonaqueous electrolyte solutions. Battery G was prepared by using the original nonaqueous electrolyte solution further containing 0.5 weight percent of boron ethoxide (B(OC₂H₅)₃) and 0.5 weight percent of triethyl phosphate.

### Comparative Example 2

In Comparative Example 2, a button-shaped lithium ion battery (Comparative Battery V) was prepared by the same procedure as in Example 2 except for the nonaqueous electrolyte solutions. Comparative Battery V was prepared by using the original nonaqueous electrolyte solution further containing 0.5 weight percent of triethyl phosphate alone.

TABLE 2

| | | | Capacity (%) |
|---|---|---|---|
| | | Content | after 20 |
| | Additive | (weight percent) | cycles |
| Battery G | Boron ethoxide | 0.5 | 93.9 |
| | Triethyl phosphate | 0.5 | |
| Comparative | Triethyl phosphate | 0.5 | 92.0 |
| Battery V | | | |

Table 2 shows the batteries according to Example 2 and Comparative Example 2, the types and contents of additives (boron ethoxide and triethyl phosphate), and ratios of the discharge capacity after 20 cycles to the discharge capacity after one cycle.

Both Battery G according to Example 2 and Comparative Battery V according to Comparative Example 2 contained 0.5 weight percent of triethyl phosphate in their nonaqueous electrolyte solutions. Battery G according to Example 2 using the nonaqueous electrolyte solution containing 0.5 weight percent of boron ethoxide showed a higher discharge capacity after 20 cycles and had a more satisfactory cycle life, as compared to Comparative Battery V using the nonaqueous electrolyte solution containing 0.5 weight percent of triethyl phosphate alone and to Comparative Battery Z using the original nonaqueous electrolyte solution containing no additive.

The lithium ion battery according to the examples (embodiments), which uses a cathode active material exhibiting a high potential of 4.5 V or more with reference to lithium metal, has an excellent cycle life because the battery is protected from a decrease in the cycle life due to the oxidation decomposition of the solvent in the nonaqueous electrolyte solution.

In addition, the lithium ion battery may solve or avoid such problems that the coulombic efficiency (the ratio of discharge capacity to charge capacity) decreases due to the consumption of electricity by the oxidation decomposition; that the solvent, by the oxidation decomposition, forms a gas which increases the inner pressure of the battery to cause expansion of the battery housing; and that the battery shows performance deterioration due to a decrease or a compositional change in the electrolyte solution.

The lithium ion batteries according to the present invention are usable as power sources using multiple batteries in series, for use typically in electric vehicles (EVs) and hybrid EVs, and in electric power storage.

What is claimed is:

1. A lithium ion battery comprising:
a cathode including a cathode active material exhibiting a potential of 4.5 V or more with reference to lithium metal;
an anode; and
a nonaqueous electrolyte solution containing a nonaqueous solvent and at least one lithium salt dissolved in the nonaqueous solvent,
wherein the nonaqueous solvent contains a cyclic carbonate and a chain carbonate, and
wherein the nonaqueous electrolyte solution contains a material represented by the following Chemical Formula 1:
B(OR¹)(OR²)(OR³) [1]
wherein at least one of R¹, R², and R³ is an alkyl group having two carbon atoms; B represents boron; and O represents oxygen.

2. The lithium ion battery according to claim 1,
wherein the material represented by the Chemical Formula 1 is a boron alkoxide.

3. The lithium ion battery according to claim 1,
wherein the nonaqueous solvent contains an ethylene carbonate as the cyclic carbonate and contains at least one of dimethyl carbonate and methyl ethyl carbonate as the chain carbonate.

4. The lithium ion battery according to claim 1,
wherein each of the alkyl groups R¹, R², and R³ of the material represented by the Chemical Formula 1 has two carbon atoms.

5. The lithium ion battery according to claim 2,
wherein the boron alkoxide is a boron ethoxide.

6. The lithium ion battery according to claim 5,
wherein the nonaqueous electrolyte solution contains the boron ethoxide in a content of 0.2 weight percent or more and 4.0 weight percent or less.
